(19) United States
(12) Patent Application Publication
(10) Pub. No.: US 2012/0036790 A1
(43) Pub. Date: Feb. 16, 2012

(54) Abrasive Material Comprising Reactive Inorganic Endothermic Compound

(75) Inventor: Michihiro Yamahara, Kanagawa (JP)

(73) Assignee: 3M Innovative Properties Company, Saint Paul, MN (US)

(21) Appl. No.: 11/718,360

(22) PCT Filed: Nov. 4, 2005
(86) PCT No.: PCT/US05/39954

§ 371 Date: Nov. 5, 2007

(30) Foreign Application Priority Data
Nov. 5, 2004 (JP) 2004-322358

(51) Int. Cl. B24D 18/00; C09K 3/14

(52) U.S. Cl. 51/309; 51/307; 51/293

(57) ABSTRACT

The invention provides a nonwoven fabric abrasive material, which comprises a reactive inorganic endothermic compound.

### BACKGROUND

The present invention relates to an abrasive material, and particularly, to a nonwoven fabric abrasive material for abrading a surface of materials such as metal, plastic and wood.

Those skilled in the art have known of a nonwoven fabric abrasive material having: a substrate such as nonwoven fabric; an adhesive agent provided on a surface of the substrate; and abrasive particles provided on the surface of the substrate, being at least partly buried in the adhesive agent.

Described in Patent literature 1 is a floor polishing pad manufactured using a low density nonwoven fabric in an open structure with a high void percentage as a substrate and a phenol-aldehyde resin solution as an adhesive agent. Described in Patent literature 2 is a surface treatment pad manufactured by laminating plural nonwoven fabric abrasive materials capable of self-renewal of a working surface by peeling off one layer at a time in a case where the working surface has been worn out with time in usage.

Described in Patent literature 3 is a grinding wheel manufactured in a way such that abrasive particles are fixed on a low density nonwoven web with an adhesive agent, wherein the adhesive agent is a mixture of polyester and polyurethane, and a polymer miscible therewith. Described in Patent literature 4 is a water-dispersible composition including a polyurethane prepolymer and an amine-functional material as a precursor of such an adhesive agent. Described in Patent literature 5 is a surface finishing product including a nonwoven fabric, a stretch-preventing, porous reinforcing woven fabric and a stretchable adhesive agent.

Described in Patent literature 6 is a manufacturing process of a nonwoven fabric abrasive material in which coated on a nonwoven fabric are a solution of a solvent-type adhesive agent including a curable resin, a curing agent and a volatile solvent, and abrasive particles to dry the adhesive agent solution and to obtain an abrasive material intermediate that can be handled; the abrasive material intermediate is shaped in a structure such as a laminate type, a flap type and a spiral type; and thereafter, the shaped abrasive material intermediate is heated to cure the adhesive agent.

Described in Patent literature 7 is a flame-retardant nonwoven fabric abrasive material, which is prepared by adhering abrasive particles to a nonwoven fabric with a phenol resin binder, which contains a phosphorous flame-retardant agent, and shaping this to a cylindrical form. The nonwoven fabric abrasive material has good self-extinguishing ability, and a fire is hardly induced even though a spark has been generated through metal abrading.

Patent literatures 8 and 9 describe a nonwoven fabric abrasive material, which comprises at least a nonwoven fabric, a resin binder, and abrasive particles. Many kinds of inorganic substances are described as examples for soft abrasive particles and fillers, which may be employed.

A substrate or an adhesive agent of a nonwoven fabric abrasive material is made of organic substances, and would be degraded with heat. Therefore it is an important subject to control heat, which is developed through abrasive working. Particularly surface fine-finish or mirror-finish working causes a large amount of frictional heat, thereby the organic substances, which form the nonwoven fabric abrasive material, are easily degraded. The degraded organic substances may adhere as contacting to a surface to be abraded, to cause a stain on the surface. The stain is generally known as smear. Generation of smear requires additional step for removing it in the course of abrasive work, and makes the abrasive work complicated.

A lubricant has generally been employed as the means for preventing heat development as conducting abrasion. The lubricant on the one hand reduces development of frictional heat, on the other hand works as a medium for take the heat out from a part to be abraded. However, a liquid lubricant involves possibility to modify a surface to be abraded, requires a step for removing itself from the surface to be abraded after abrading, and makes the abrasive work complicated. A solid lubricant does not have sufficient ability for reducing frictional heat.

### BRIEF DESCRIPTION OF THE DRAWING

FIG. 1. is a perspective view illustrating a cylindrical grinding brushes of typical structure types each having a central hole.

FIG. 2. is an exemplary illustration of a process of obtaining an abrasive material intermediate used in manufacturing a nonwoven fabric abrasive material of a three-dimensional shape.

FIG. 3. is an exemplary illustration of a process of manufacturing a nonwoven fabric abrasive material of a three-dimensional shape using an abrasive material intermediate.

FIG. 4. is a close-up photograph showing an abraded surface of an ABS resin plate, abraded with an abrasive material of the present invention.

FIG. 5. is a close-up photograph showing an abraded surface of a PP resin plate, abraded with an abrasive material of the present invention.

FIG. 6. is a close-up photograph showing an abraded surface of an ABS resin plate, abraded with a conventional abrasive material.

FIG. 7. is a close-up photograph showing an abraded surface of a PP resin plate, abraded with a conventional abrasive material.

### SUMMARY

One aspect of the present invention is directed to solving the problems described above in the art and it provides a nonwoven fabric abrasive material which has improved heat control ability, and does not generate smear as conducting dry abrasion.

### DETAILED DESCRIPTION

Generally, the present invention provides an abrasive material comprising a reactive inorganic endothermic compound. One exemplary embodiment of the abrasive material includes a nonwoven fabric abrasive material having: a nonwoven fabric made of fibers; an adhesive agent adhered onto surfaces of fibers of the nonwoven fabric; and a reactive inorganic endothermic compound adhered to the nonwoven fabric with the adhesive agent.

A nonwoven fabric abrasive material of the present invention has excellent heat control ability as conducting abrasive work. Therefore it does not generate smear even when fine surface finishing or mirror finishing is conducted through dry mode. In addition, the nonwoven fabric abrasive material does not degrade an object to be abraded with heat, so it is able to be employed for abrading a resin, specifically a thermoplastic resin which has been difficult to be abraded.

A nonwoven fabric employed in the present invention is a bulky sheet-shaped material made of fibers arranged at random. Suitable nonwoven fabrics are well known to those skilled in the art as a substrate for a nonwoven fabric abrasive material. Typical nonwoven fabrics are described in Japanese Patent Laid-Open Publication No. H3(1991)-55270 (line 10 in column 10 to line 25 in column 11).

Preferable nonwoven fabrics include: those made from thermoplastic organic fibers such as fibers made of polyamides (for example, Nylon 6 and Nylon 6, 6 made from polycaprolactam and polyhexamethyladipamide); polyolefins (for example, polyethylene and polypropylene); polyesters (for example, polyethylene terephthalate); polycarbonates; and the like. Nonwoven fabrics generally employed have been made from Nylon fibers and polyester fibers. Thickness values of fibers thereof are generally on the order in the range of from 19 to 250 μm in diameter. A thickness of a nonwoven fabric is generally on the order in the range of from 2 to 50 mm.

The adhesive agent is a material bonding a nonwoven fabric and abrasive particles together. Such a material has only to be of enough strength to maintain bonds between a nonwoven fabric and abrasive particles during abrading. Generally speaking, an adhesive agent contains a binder resin and an additive as components. The binder resin is an organic resin exerting a function to bond a material to another because of a change in phase from a coatable liquid to a rigid solid. The precursor of a binder is referred especially to as an adhesive agent in a liquid state of the binder resin.

Examples that can be used as a binder resin are phenolic resin, urea-formaldehyde resin, shellac, epoxy resin, isocyanurate, polyurethane, hide glue and the like.

A binder resin preferably used in a nonwoven fabric abrasive material of the preset invention is a comparatively rigid organic resin. Parameters of such a binder resin are as follows: the tensile strength of a binder resin after curing is generally 3000 psi or higher, preferably in the range of from 3000 to 11000 psi; the elongation percentage is generally 180% or more, preferably in the range of from 180 to 800%; the Shore D hardness is generally 40 or higher, preferably in the range of 40 to 80; and the elastic modulus is 1 MPa or more, preferably in the range of from 10 to 50 MPa.

If the tensile strength of a binder resin is lower than 20 MPa (3000 psi), a strength and a stiffness of an adhesive agent after the curing is too low to suit a nonwoven fabric abrasive material. If an elongation percentage is less than 180%, a flexibility of an adhesive agent after the curing is too low to suit a nonwoven fabric abrasive material. If a Shore D hardness is lower than 40, abrasive particles are easy to fall off from a nonwoven fabric abrasive material during grinding. If the elastic modulus is less than 1 MPa, a strength and a stiffness of an adhesive agent after the curing is too low to suit a nonwoven fabric abrasive material.

An specific example of such a resin is polyurethane resin. See, for example, Japanese Patent Kokoku Publication No. 61-37064, column 10, lines 4 to 32. Commercially available examples are; Adiprene L type resins produced by Uniroyal Chemical Co. (for example, L-42, L-83, L-100, L-167, L-200, L-213, L-300, L-315 and the like); ADEKA BONTIGHTER type resins produced by Asahi Denka Co., Ltd. (for example, HUX-232, HUX-240, HUX-260, HUX-320, HUX-350, HUX-380, HUX-381, HUX-380A, HUX-386, HUX-401, HUX-670, HUX-290H, HUX-260N, HUX-394, HUX-680 and the like); and the others.

In preparation of such a polyurethane resin, generally used are a polyol component, a curing agent component therefor and the like. Examples of the curing agent are: isocyanates such as 4,4′-methylenedis-2-chloroaniline (MOCA); isocyanates having a terminal blocked with ketoxime; p,p′-methylenedianiline, which is a phenol having a terminal treated with 4,4′-methylenebisaniline; a melamine type resin (for example, “MELAN 5100 produced by Hitachi Chemical Co., Ltd.) and the like. A preferable example is a urethane resin containing a curing agent in the range of from 3 to 10% by weight in terms of an NCO amount or a melamine amount.

An aqueous adhesive agent precursor may be employed in the present invention. An aqueous adhesive agent precursor is an adhesive agent precursor including water mainly as a solvent. An aqueous adhesive agent precursor generally takes a state where a binder resin is uniformly dispersed in water, which is referred to as an emulsion or a suspension. A resin capable of being uniformly dispersed in water is referred to as a water-dispersible resin.

An uncured binder resin is preferably required to be water-dispersible and thermocurable. This is because that it is easy to obtain a nonwoven fabric abrasive material by shaping. It is preferable that a binder resin has a curing temperature in the range of from 100 to 300° C. and especially in the range of from 100 to 200° C. If a curing temperature of a binder resin is lower than 100° C., curing may become insufficient, abrasive particles become easy to drop, and grinding ratio becomes poor. On the other hand, if a curing temperature thereof exceeds 300° C., the binder resin may be decomposed, abrasive particles become easy to drop, and grinding ratio becomes poor.

An uncured binder resin preferably shows no tackiness even if being touched with a finger or the like in an environment at room temperature. This is because it is easy to handle an abrasive material intermediate obtained by coating an adhesive agent precursor on an nonwoven fabric to then dry the adhesive agent thereon.

A preferable binder resin is a thermocurable resin, including an isocyanate-terminated polymer having an anionic group, a thermocurable acrylic polymer having a hydroxyl group and a melamine-based crosslinking agent, and showing water-dispersibility. A combination of an isocyanate polymer, which is a soft segment, and an acrylic polymer, which is a hard segment, can adjust characteristics of a binder resin optimally in order to adhere abrasive particles to a nonwoven fabric.

As a result, an aqueous adhesive agent precursor employed in the present invention has a strength for holding abrasive particles equal to or higher than that of a solvent-type adhesive agent precursor to thereby prevent the abrasive particles to fall off from a nonwoven fabric and enable the nonwoven fabric to be provided with a proper self-renewal function so as to enable grinding with a fresh grinding surface to be effected at all times.

An isocyanate-terminated polymer having an anionic group, a thermocurable acrylic polymer having a hydroxyl group and a melamine-based crosslinking agent may be each mixed together in a state of an emulsion or a water-dispersion.

Employed is an isocyanate-terminated polymer having an anionic group in a molecule thereof alone or a mixture of an isocyanate-terminated polymer having no anionic group and an isocyanate-terminated polymer having an anionic group in a molecule thereof, and it is preferable to use a resin component (a mixture of an isocyanate-terminated polymer having an anionic group in a molecule thereof and an isocyanate-terminated having no anionic group in a molecule thereof) having an anionic group in the range of from 0.001 to 0.5 equivalent relative to 100 g of the total amount the resin, which the resin component is good in water-dispersibility to thereby enable a water-dispersion thereof to be obtained without using an emulsifier or a dispersing agent. Exemplified as the anionic group are a carboxyl group, a sulfone group and a combination thereof, among which a carboxylic group is preferable.

The isocyanate-terminated polymer having an anionic group in a molecule thereof can be obtained by means of a conventionally known method and in a case of introduction of carboxyl group as an example, the polymer can be obtained through a reaction of a polyisocyanate with a polyether polyol and/or a polyester polyol, as a polyol component, having a diol unit including a carboxyl group such as 2,2-dimethylolpropionic acid, 2,2-dimethylolbutric acid, 2,2-dimethylolvaleric acid or the like.

A polyol component of polyether polyol and/or polyester polyol used in obtaining an isocyanate-terminated polymer having an anionic group in a molecule thereof and an isocyanate-terminated polymer having no anionic group in a molecule thereof is desirably of an average molecular weight in the range of from 500 to 4000, wherein a polyisocyanate component is not specifically limited and examples thereof include aliphatic polyisocyanates such as tetramethylene diisocyanate, hexamethylene diisocyanate, lysine diisocyanate and the like; alicyclic polyisocyanates such as 1,4-cyclohexylene diisocyanate, isophorone diisocyanate, 4,4′-dicyclohexyl diisocyanate and the like; and aromatic polyisocyanates such as tolylene diisocyanate, 4,4-diphenylmethane diisocyanate and the like, among which an aliphatic or alicyclic polyisocyanate is preferable.

An isocyanate-terminated polymer described above may also be an isocyanate-terminated polymer chain-extended with dialkyl amine, dialkyl hydrazide or the like, any of which can be optionally selected according to an application in the range as far as a water-dispersion can be obtain. Water-dispersions of a polymer having an anionic group in a molecule thereof are sold on the market, examples of which include the polymers of “BONTIGHTER” type, manufactured by Asahi Denka Co., Ltd., as described above.

A thermocurable acrylic polymer having a hydroxyl group is preferably an acrylic polymer emulsion obtained by uniformly dispersing in water. The acrylic polymer has a hydroxyl value in the range of from 40 to 100. If the hydroxyl group is less than 40, the number of reaction sites is small to thereby cause a reaction insufficiently, disabling the object of the present invention to be achieved. On the other hand, if the hydroxyl value exceeds 100, waterproofness of an adhesive agent after curing is reduced. The acrylic polymer has an acid value in the range of from 1 to 30. If the acid value is less than 1, a stable emulsion is hard to be obtained, while if exceeding 30, a hydrophilicity of a polymer is enhanced; therefore, an emulsion becomes of a high viscosity and a waterproofness of an adhesive agent is reduced. The acrylic polymer has a glass transition temperature in the range of from −40 to 10° C. If the glass transition temperature is lower than −40° C., an adhesive agent has faults in physical strength and durability, while if higher than 10° C., a hardness of an adhesive agent increases and a flexibility thereof in low temperature is reduced.

An acrylic polymer emulsion is prepared from unsaturated monomers as described below:

1. Examples of acrylic-based monomers each having a hydroxyl group include ethylenic unsaturated monomers each having a hydroxyl group such as 2-hydroxyethyl acrylate, 2-hydroxyethyl methacrylate, 2-hydroxypropyl methacrylate, 2-hydroxypropyl acrylate, lactone-modified 2-hydroxyethyl acrylate, and lactone-modified 2-hydroxyethyl methacrylate.

2. Examples of alkyl esters of acrylic acid or methacrylic acid include methyl acrylate, ethyl acrylate, propyl acrylate, isopropyl acrylate, butyl acrylate, hexyl acrylate, octyl acrylate, lauryl acrylate, cyclohexyl acrylate, methyl methacrylate, ethyl methacrylate, propyl methacrylate, isopropyl methacrylate, butyl methacrylate, hexyl methacrylate, octyl methacrylate, lauryl methacrylate and the like.

3. Examples of α,β-ethylenically unsaturated carboxyl acids include acrylic acid, methacrylic acid, crotonic acid, itaconic acid, maleic acid, maleic anhydride, fumaric acid and the like.

4. Examples of vinyl aromatic compounds include styrene, α-methylstyrene, vinyltoluene, p-chlorostyrene, vinylpyridine and the like.

5. Examples of other vinyl compounds include ethylene glycol diacrylate, ethylene glycol dimethacrylate, triethylene glycol diacrylate, tetraethylene glycol dimethacrylate, 1,6-hexanediol diacrylate, divinylbenzene, trimethylolpropane triacrylate and the like.

The unsaturated monomers can be used in mixtures of an acrylic monomer including a hydroxyl group and an α,β-ethylenically unsaturated carboxyl acid monomer as indispensable components; and if necessary, an alkyl ester of acrylic acid or methacrylic acid and other vinyl compounds; and the like, wherein kinds and a mixing ratio of each can be properly selected according to a desired physical property of a resin.

Preferable examples of chain transfer agents for adjusting a molecular weight include methyl mercaptan, ethyl mercaptan, isopropyl mercaptan, butyl mercaptan, pentyl mercaptan, hexyl mercaptan, octyl mercaptan, decyl mercaptan, undecyl mercaptan, dodecyl mercaptan, t-dodecyl mercaptan and the like.

Production of a copolymer included in an acrylic polymer emulsion of the present invention is performed according to a known method and can be realized with, for example, a solution polymerization method, an emulsion polymerization method or a suspension polymerization method, among which the emulsion polymerization method is preferable. The polymerization generally goes this way, in which monomers are three-dimensionally crosslinked in the presence of a dispersion stabilizer such as a surfactant and a polymerization initiator, for example a radical initiator for a radical polymerization such as ammonium persulfate or the like, at a reaction temperature, preferably, in the range of from 60 to 95° C. for a time, preferably in the range of from 4 to 8 hr, and then, the reaction mixture is neutralized with an amine, thereby enabling a target acrylic polymer emulsion to be obtained. Diameters of fine particles in the obtained acrylic polymer emulsion are preferably in the range of from 50 to 200 nm.

Such a microemulsion is on the market and examples thereof include “Hitaloid type” manufactured by Hitachi Chemical Co., Ltd., product No. AE8200, and the like.

Melamine-based crosslinking agents have only to be known melamine-based crosslinking agents as a crosslinking agent for synthetic resin. The agents can be dispersed in water either with an emulsifying agent or a dispersing agent, if necessary, or without them. A melamine-based crosslinking agent is not specifically limited and exemplified are “Melan 5100” manufactured by Hitachi Chemical Co., Ltd., and the like.

Mixing proportions of components of a thermocurable aqueous adhesive agent precursor are generally 100 parts by weight of an isocyanate-terminated polymer having an anionic group; 1 to 50 parts by weight of a thermocurable acrylic polymer having an hydroxyl group; and 0.01 to 20 parts by weight of a melamine-based crosslinking agent. If an amount of a thermocurable acrylic polymer having a hydroxyl group is less than 1 part by weight, a flexibility of an adhesive agent after curing is excessively high by the action of a characteristic of an isocyanate-terminated polymer having an anionic group so as not to suit a nonwoven fabric abrasive material, while if exceeding 50 parts by weight, a flexibility of an adhesive agent after curing is excessively low so as not suit a nonwoven fabric abrasive material. If an amount of a melamine-based crosslinking agent is less than 0.01 part by weight, a flexibility of an adhesive agent after curing is excessively high so as not to suit a nonwoven fabric abrasive material, while exceeding 20 parts by weight, a flexibility after curing is excessively small so as not to suit a nonwoven fabric abrasive material.

A reactive inorganic endothermic compound employed for a nonwoven fabric abrasive material of the present invention is a solid inorganic substance, which is allowed to react with heat generated as conducting abrasive work, and to transform into metal oxide, with absorbing heat during reaction. The reactive inorganic endothermic compound preferably has a reaction temperature of not more than 300° C. This is because polyester such as nylon 6, 6 is useful as fibers for the nonwoven fabric, and heat-resistant temperature of the polyester fibers is about 300° c. Preferably the reactive inorganic endothermic compound has a reaction temperature of not more than 100 to 250° C., more preferably 150 to 230° C.

Specific examples of the reactive inorganic endothermic compound include aluminum hydroxide, calcium hydroxide, calcium aluminate, magnesium hydroxide, fibriform magnesium hydroxide, basic magnesium carbonate, zinc borate, ammonium polyphosphate, dosonite, hydrotalcite and the like. Preferable examples of the reactive inorganic endothermic compound include aluminum hydroxide, hydrotalcite, calcium aluminate and basic magnesium carbonate, particularly preferred is aluminum hydroxide and hydrotalcite.

The reactive inorganic endothermic compound is employed in an amount of from 10 to 300 parts by weight based on 100 parts by weight of the adhesive agent, preferably 10 to 200 parts by weight, more preferably 30 to 100 parts by weight. Lower amount (e.g., not more than 10 parts by weight) of the reactive inorganic endothermic compound decreases endothermic function, and more than 300 parts by weight impairs adhesive strength so as to be inappropriate for a nonwoven fabric abrasive material.

Abrasive particles may be employed in the nonwoven fabric abrasive material of the present invention dependent on purpose. Abrasive particles employed in the present invention are those commonly used in the technical field to which the present invention pertains. An average diameter of abrasive particles is generally in the range of from 4 to 2000 μm and preferably in the range of from 20 to 1000 μm and a Mohs hardness thereof is generally in the range of from 4 to 10 Mohs and preferably in the range of from 6 to 9 Mohs. Specific examples that can be used are: particles of pumice, topaz, garnet, alumina, corundum, silicon carbide, zirconia, diamond and the like. The particles may be a mixture in diameter of a single kind or a mixture of different kinds.

A nonwoven fabric abrasive material of the present invention can be produced based upon a process known to those skilled in the art. For example, a needle-shaped filler is added into a liquid binder resin and dispersed in the resin to a sufficient uniformity to thereby prepare an adhesive agent precursor. The liquid binder resin may be a solution form or an aqueous dispersion form. The precursor of an adhesive agent is coated on surfaces of fibers of a nonwoven fabric. Abrasive particles are scattered on the precursor of an adhesive agent as a coat and attached there. An organic solvent, water and the like are vaporized from the adhesive agent precursor to dry. The precursor of an adhesive agent is then cured. In a case where a thermocurable plastic is used as a binder resin, the precursor of an adhesive agent is heated for a predetermined time and cured. An adhesive agent precursor is generally cured maintained at a temperature in the range of 100 to 300° c. for a time in the range of 10 to 30 min.

abrasive particles are added in advance in preparation of an adhesive agent precursor and the precursor of an adhesive and the abrasive particles may be simultaneously coated on a nonwoven fabric. Furthermore, drying of the adhesive agent precursor and curing of the thermocurable resin may be conducted either in the same heating step or in different heating steps. Even in a case where the drying of the adhesive agent precursor and the curing of the thermocurable resin are implemented in different steps, the thermocurable resin can be partly cured in the drying step without causing any trouble.

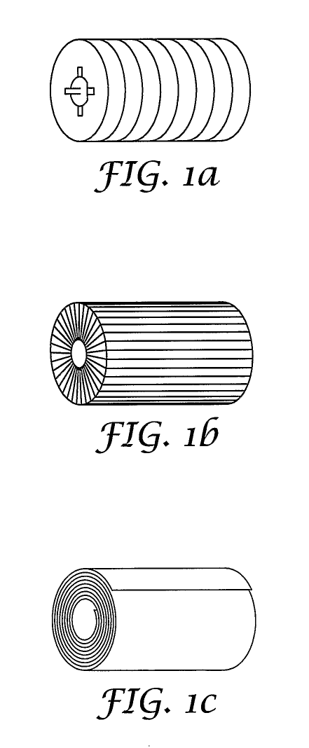

As described above, a nonwoven fabric used as a substrate is a bulky fibrous material and excellent in elasticity; therefore, easy deformation and restoration can be secured. Therefore, a laminate including plural nonwoven fabric layers is easy in deformation and can be shaped with a relative freedom under a pressure. In a preferred embodiment of the present invention, a nonwoven fabric abrasive material of a three-dimensional shape is manufactured with the help of an easily shapable nonwoven fabric. A typical example of a nonwoven fabric abrasive material of a three-dimensional shape is a cylindrical grinding brush having a center hole. FIG. 1 is a perspective view showing typical structure types of cylindrical grinding brushes each having a center hole: (a) shows a view of a laminate type, (b) a flap type and (c) a spiral type.

FIG. 2 is a model representation showing a process of manufacturing an abrasive material intermediate used in manufacturing a nonwoven fabric abrasive material of a three-dimensional shape. At first, a nonwoven fabric 10 is sent out from a roll 100 of a nonwoven fabric. Then, the nonwoven fabric 10 is impregnated with a mixture of an adhesive agent precursor and abrasive particles. The impregnated nonwoven fabric is heated to fix a thermocurable resin and the abrasive particles on surfaces of fibers of the nonwoven fabric. The adhesive agent precursor is spray-coated on the surface thereof.

Then, an organic solvent, water and the like, are evaporated from the adhesive agent precursor to dry it in a drying furnace. The drying is conducted at a temperature for a time in the combination of which the thermocurable resin is not perfectly cured so that the adhesive agent precursor is of non-tackiness at room temperature. This is because if the adhesive agent precursor still sustains a tackiness at room temperature after the drying step, it becomes difficult to handle and work the obtained abrasive material intermediate and because if the thermocurable resin is perfectly cured after the drying step, it becomes difficult to shape the abrasive material intermediate thereafter. In a preferable embodiment of the present invention, the drying step is conducted at a temperature in the range of from 100 to 120° c. for a time in the range of from 1 to 10 min. After the drying step, the obtained abrasive material intermediate 20 loses tackiness and thereby can be handled. Therefore, the abrasive material intermediate 20 can be taken up and stored as a roll 200.

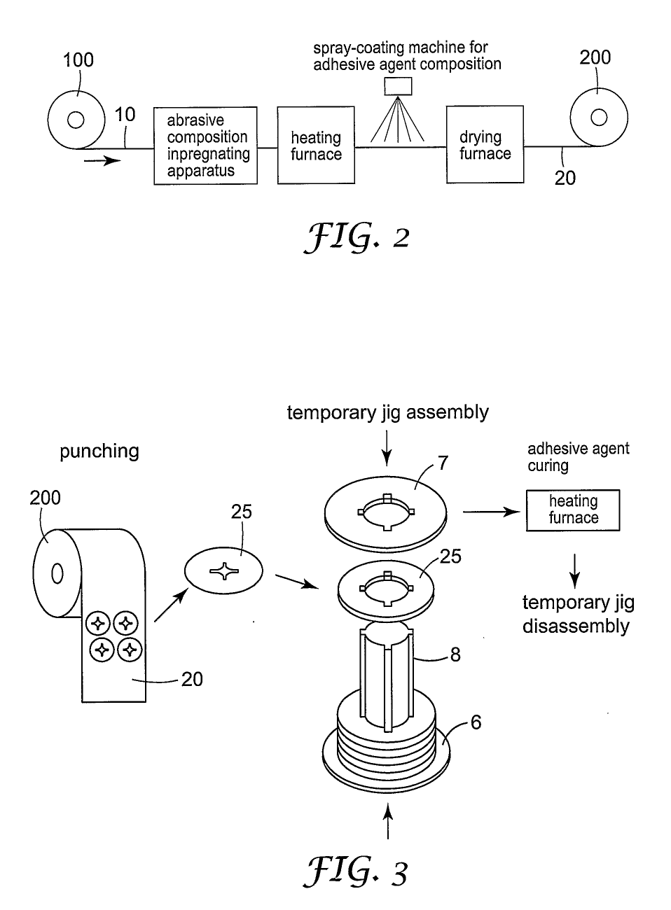

FIG. 3 is a model representation showing a process of manufacturing a nonwoven fabric abrasive material of a three-dimensional shape using an abrasive material intermediate. At first, the abrasive material intermediate 20 is sent out from the roll 200 of the abrasive material intermediate. Then, the abrasive material intermediate 20 is punched therethrough into proper shapes to obtain intermediate members 25. Jigs 6, 7 and 8 are used to superimpose plural intermediate members 25 one on another and the superimposed intermediate members 25 are compressed to a high density. Thereafter, the intermediate members 25 are heated in a compressed state to completely cure the adhesive agent precursor and to thereby fix a shape thereof. In the preferred embodiment, the heat curing step is conducted at a temperature in the range of from 100 to 200° C. for a time in the range of from 10 to 60 min. In such a heat curing step, a cylindrical grinding brush having a center hole can be obtained (see FIG. 1(a)).

The nonwoven fabric abrasive material of the present invention is suitable for the use in which fine finishing is required rather than abrasive power. An example of the use includes fine surface finishing such as mirror finishing. The nonwoven fabric abrasive material of the present invention is also suitable for abrading a material, which is poor in heat resistance. Examples of the material include resin, particularly thermoplastic resins and plastic materials.

A process for using the nonwoven fabric abrasive material of the present invention is the same as for the conventional nonwoven fabric abrasive material. That is, the nonwoven fabric abrasive material is allowed to contact with a surface of a material to be abraded, and they are relatively moved with pressure being applied. The abrasion process is usually conducted by rotating the nonwoven fabric abrasive material with making a major surface thereof to contact with a surface of the material to be abraded. Abrasive conditions such as abrasive load, abrasive speed, and abrasive period may appropriately be determined.

While detailed description will be given of the present invention using examples, the present invention is not limited to the detailed description and unless otherwise described definitely in the examples, the term “part or parts” indicates those by weight.

### EXAMPLE 1

Aluminum hydroxide (“B 103” produced by Nippon Keikinzoku K.K.) was obtained as the reactive inorganic endothermic compound. As a binder resin, a urethane resin emulsion manufactured by Asahi Denka Co., Ltd. “BONTIGHTER HUX-380” was obtained. Physical properties of the urethane resin (after cured) was such that the tensile strength was 38 MPa (5500 psi), the elongation percentage was 500%, the Shore D hardness was 45, and the elastic modulus was 8.4 MPa. As abrasive particles, aluminum oxide having an average particle size of 1 μm (“WA8000” produced by Fujimi Incorporated) was obtained. Further, as a nonwoven fabric, a circular nonwoven fabric composed of 6 denier×38 mm nylon 6,6 fibers having a basis weight of 440 g/m², a thickness of 10 mm and a diameter of 10 cm was prepared.

50 parts of aluminum hydroxide as the reactive inorganic endothermic compound and 300 parts of the abrasive particles were added to 100 parts of the urethane resin, and the mixture was kneaded to obtain a coating liquid. The coating liquid was coated by means of a spraying method on both surfaces of the nonwoven fabric. A dry-coat amount of the coating liquid was 880 g/m². Thereafter, the material was put into an oven and heated at 110° C. for 20 min to at least partially cure the adhesive precursor. Thereby a nonwoven fabric abrasive disk was obtained.

The nonwoven fabric abrasive disk was urged against a major surface of a stainless steel plate and rotated to conduct an abrasive test. A stainless steel plate (SS#304) was employed as the workpiece. Abrading conditions were such that a load was 2000 g/cm², an abrading speed was 10000 rpm, and the abrading time was 5 sec.

After the abrading, surface temperature of the work piece was measured with a radiation thermometer (“THERMOMETER TR-0510b” produced by Minolta K.K.) at a point 10 mm apart from the abrasive disk, and determined to be 150° C. An abraded surface of the work piece was inspected and found to be mirror finished without smearing.

### EXAMPLE 2

A nonwoven fabric abrasive disk was prepared in a similar manner as described in Example 1 except that the abrasive particles were not employed, and the abrasive test was conducted. An abraded surface of the workpiece was inspected and found not to be smeared. The other results were shown in Table 1.

### EXAMPLE 3

Example 3 was prepared identically to Example 1 except that 100 parts of hydrotalcite (“DHT-6” produced by Kyowa Chemical Industry Co., Ltd.) was substituted for the aluminium hydroxide. The temperature of the workpiece after abrading was determined to be 130° C. The workpiece was mirror finished without smearing.

### EXAMPLE 4

Example 4 was prepared identically to Example 3 except that no abrasive particles were added. Comparative test results are shown in Table 1.

### COMPARATIVE EXAMPLE 1

A nonwoven fabric abrasive disk was prepared in a similar manner as described in Example 1 except that the reactive inorganic endothermic compound was not employed, and the abrasive test was conducted. An abraded surface of the workpiece was inspected and found to be mirror finished in part with smearing. The other results were shown in Table 1.

### COMPARATIVE EXAMPLE 2

A nonwoven fabric abrasive disk was prepared in a similar manner as described in Example 1 except that: a) the reactive inorganic endothermic compound was not employed; and b) the abrasive particles were not employed. When the abrasive test was conducted, the abraded surface of the workpiece was inspected and found to be smeared. The other results are shown in Table 1 (below).

TABLE 1

| Example No. | 1 | 2 | 3 | 4 | Comp. 1 | Comp. 2 |
|---|---|---|---|---|---|---|
| Urethane resin adhesive | 100 | 100 | 100 | 100 | 100 | 100 |
| agent (parts) | | | | | | |
| Aluminum hydroxide | 50 | 50 | 0 | 0 | 0 | 0 |
| (parts) | | | | | | |
| Hydrotalcite-like* | 0 | 0 | 100 | 100 | 0 | 0 |
| compound (parts) | | | | | | |
| Aluminum oxide (parts) | 300 | 0 | 300 | 0 | 300 | 0 |
| Surface temperature after | 150 | 160 | 130 | 160 | 200 | 210 |
| abrading (° C.) | | | | | | |
| Smearing | No | No | No | No | Yes | Yes |

*Hydrotalcite-like compound: DHT-6 produced by Kyowa Chemical Industry Co., Ltd. Mg₆Al₂(OH)₁₈CO₃•4H₂O

The results of Table 1 show that heat-development was suppressed, and smearing was controlled even when fine surface finishing or mirror finishing is conducted through dry mode.

### EXAMPLE 5

An ABS resin plate (“ABS-NWN” produced by Shin-Kobe Denki K.K.) and a PP resin plate (“PP-NBN” produced by Shin-Kobe Denki K.K.) having a thickness of about 25 mm were prepared. The ABS resin and the PP resin are both thermoplastic resins having a softening temperature of about 100° C. Abrading was conducted with an abrasive disk identical to the disk of Example 1 except that the resin plates were employed as the work piece.

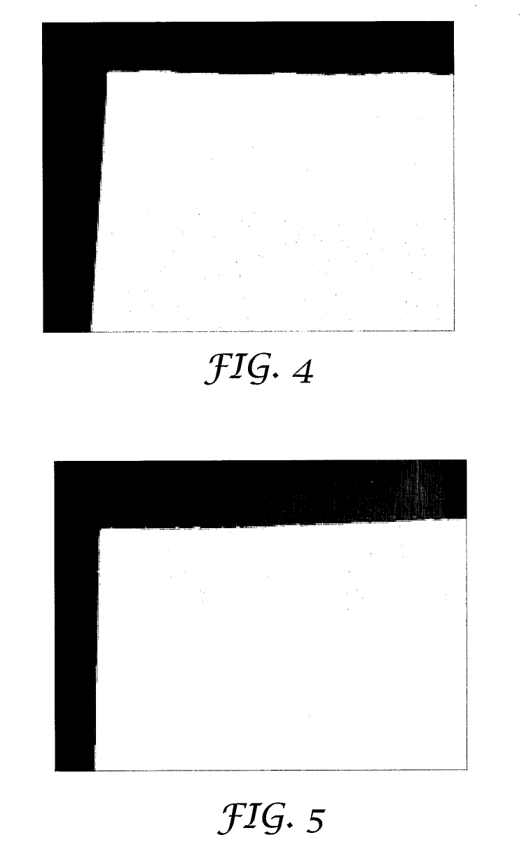

An abraded surface of the work piece was inspected and found no mark of having melted from frictional heat. FIG. 4 is a picture showing the abraded surface of the ABS resin plate. FIG. 5 is a picture showing the abraded surface of the PP resin plate.

### COMPARATIVE EXAMPLE 3

Abrading was conducted with an abrasive disk as described in Comparative Example 1 except that an ABS resin plate (“ABS-NWN” produced by Shin-Kobe Denki K.K.) and a PP resin plate (“PP-NBN” produced by Shin-Kobe Denki K.K.) having a thickness of about 25 mm were employed as the work piece.

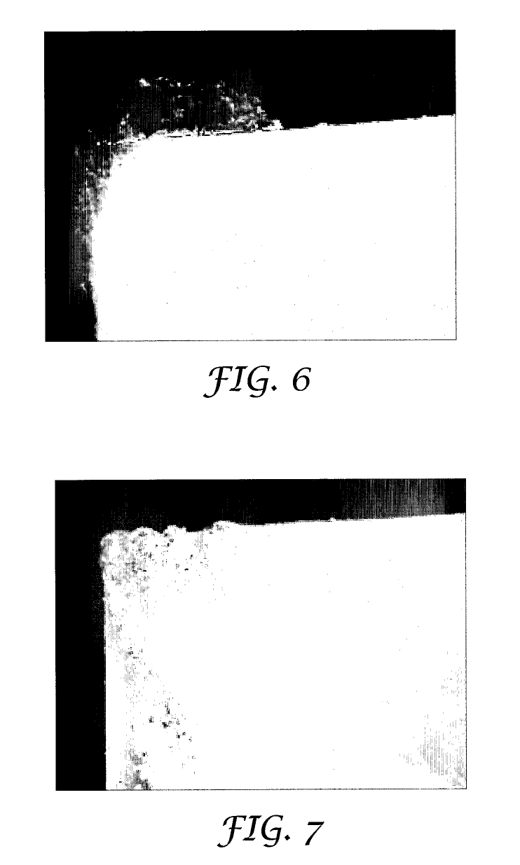

An abraded surface of the work piece was inspected and found that the resin had melted from frictional heat to produce black soil together with abrasive dust. FIG. 6 is a picture showing the abraded surface of the ABS resin plate. FIG. 7 is a picture showing the abraded surface of the PP resin plate.

Such improvements on a nonwoven fabric abrasive material in characteristic have been recognized in not only a grinding disk of a laminate type described above but also grinding brushes of a spiral type and a flap type and others.

What is claimed is:

1. An abrasive material comprising a reactive inorganic compound.

2. The abrasive material according to claim 1, wherein the abrasive material is a nonwoven fabric abrasive material having: a nonwoven fabric; an adhesive agent adhered onto surfaces of the fibers of the nonwoven fabric; and a reactive inorganic endothermic compound adhered to the fibers of the nonwoven fabric by the adhesive agent.

3. The abrasive material according to claim 2, further having abrasive particles adhered to the fibers of the nonwoven fabric by the adhesive agent.

4. The abrasive material according to claim 2 or 3, wherein the reactive inorganic endothermic compound has a reaction temperature of not more than 300° C.

5. The abrasive material according to any one of claims 1 to 4, wherein the reactive inorganic endothermic compound is at least one selected from the group consisting of aluminum hydroxide, calcium aluminate and basic magnesium carbonate.

6. The nonwoven fabric abrasive material according to any one of claims 1 to 5, wherein the reactive inorganic endothermic compound is contained in an amount of from 10 to 300 parts by weight based on 100 parts by weight of the adhesive agent.

7. A process for abrading a plastic material comprising: frictionally contacting the nonwoven fabric abrasive material according to any one of claims 1 to 6 with a surface of a plastic material, and moving at least one of the nonwoven fabric abrasive material or the plastic material relative to the other to abrade the plastic material.
